(19) United States
(12) Patent Application Publication
(10) Pub. No.: US 2024/0226946 A1
(43) Pub. Date: Jul. 11, 2024

(54) Method to control hurricanes by short circuiting the electrical charges with salt water streams

(71) Applicant: Vasudevacharya Jayarama, Framingham, MA (US)

(72) Inventor: Vasudevacharya Jayarama, Framingham, MA (US)

(21) Appl. No.: 17/300,325

(22) Filed: Apr. 26, 2022

(51) Int. Cl. B05B 17/00

(52) U.S. Cl. CPC B05B 17/00

(57) ABSTRACT

Hurricanes and intense storms generally have organized structures which are formed by the unimpeded flow of air in the atmosphere. They have immense energy associated with them in the form of potential energy which dissipates by the conversion of this energy to the kinetic energy of the wind motion and to the energy in the electromagnetic spectrum in the form of lightning and thunder. It is proposed that the conversion of the potential energy to the kinetic energy of wind motion can be reduced by enhancing the conversion to the energy in the electromagnetic spectrum. This can be accomplished by shooting jet streams of sea water into the clouds to short circuit the built-up electrical charge.

### SUMMARY:

Hurricanes and intense storms generally have organized structures which are formed by the unimpeded flow of air in the atmosphere. They have immense energy associated with them in the form of potential energy which dissipates by the conversion of this energy to the kinetic energy of the wind motion and to the energy in the electromagnetic spectrum in the form of lightning and thunder. This can be accomplished by shooting jet streams of sea water into the clouds.

### OBJECTIVE:

To reduce the kinetic energy of hurricanes and violent storms by increasing the conversion of the potential energy of the storm system in to energy in the electromagnetic spectrum by short circuiting the static electricity of the clouds which results in increased lightning and thunder. The short circuiting is accomplished by shooting jet streams of salt water into the cloud systems.

### BACKGROUND AND HYPOTHESIS:

Hurricanes and intense storms generally have organized structures which are formed by the unimpeded flow of air in the atmosphere. They have immense energy associated with them which leads to violent wind gusts and wind blows that cause immense destruction. Their energy is derived from the latent heat of the moisture which is released (a) by the interaction between the warm fronts and cold fronts and the resulting wind shear, and (b) by the rapid cooling of the moist air which occurs by Joule- Thomson effect due to the sudden expansion of the air which occurs due to the lower ambient atmospheric pressure at higher elevations. Hence, there is a tremendous amount of potential energy released from the latent heat of condensation which dissipates in two ways: (1) as kinetic energy which results in increased wind flow which, when it becomes organized, leads to the formation of violent storms, tornadoes and hurricanes; and (2) by lightning and thunder where the potential energy is converted into electromagnetic and sound energy. It is proposed that the conversion of the potential energy of the storm systems to wind movement can be reduced by increasing the conversion to the energy in the electromagnetic spectrum, which are much less harmful than intense wind: This would be accomplished by short circuiting the electrical static between the clouds. The proposed mechanism is akin to the discharge of an electrical capacitor by short circuiting it. While there are several ways to short circuit the clouds, one of the cheapest would be to shoot streams of sea water (i.e. a solution with a relatively high concentration of mainly sodium chloride in water). It is hypothesized that if the streams are long enough to span the distance between the clouds and contiguous, their relatively low conductivity (compared to traditional electrical conductors such as copper wire) would be sufficient to discharge the electrical energy in the clouds. While most inorganic salt solutions, acids and bases are better conductors of electricity than pure water, sodium chloride happens to be an efficient electrolyte which dissociates in to its component ions, sodium and chloride. This makes the sea water an ideal candidate for this use since it is free as well as efficient.

Methodology: The jet streams of salt water are proposed to be generated by ships or vehicles on the water or the ground surfaces respectively. Alternately, they could also be generated from air craft flying above and away from the thunder storm or the hurricane clouds. Ideally, these would be stationary vehicles at the surface, which are evacuated at the time of generation of the streams, since there is always a potential for the streams to connect a thunder bolt to the source of the stream. In the case of air craft, these would be remotely operated drones. The streams should be continuous in length but with finite limits such that the stream forms a thread like arc that flies through the air (like the flying arcs of water seen in amusement park water fountains). This would minimize the chances of the stream short circuiting between the stream generating vehicle and a cloud. Shooting down the arcs through the clouds down below is a safer alternative but can be more expensive.

Since lightning is known to occur intra-cloud, inter cloud and cloud to ground, there is no precise estimate of the minimum length that a stream needs to be of to connect two clouds. The following calculations are for a stream that is 2 kilometers (km) long and 2 centimeters (cm) in diameter. Calculating the volume as a cylinder, the volume of the squirt would be:

$$V = {pixr}^{2} \times h = 3.14 \times 1 cm \times 1 cm \times 2 km = 3.14 \times 200 , 000 {cm}^{3} ( 1 km = 100 , 000 cm ) = 628 , 000 millimeters ( mL ) = {}^{∼} 600 liters ( L )$$

It should be possible to generate pump out sea water in arcs of this with the current technology available.

### Claims and Embodiments:

What is claimed is a method to safely weaken hurricanes and storms by converting the potential energy of the storm systems to electromagnetic energy that is safer than the kinetic energy of wind motion which is destructive:

claim 1—use of single separate contiguous streams of sea water to act as a conductor between and within the clouds to short circuit the built up static electric charges and dissipate the energy in the form of electromagnetic radiation.

Claim 2—the above system could also be used to reduce the incidence of destructive cloud to ground lightning by increasing the occurrence of intra-cloud and cloud-to-cloud lightning.

The following embodiments are proposed:
1. In its simplest embodiment, the arc of sea water would be a few meters long and launched from surface based vehicles in to the thunder storm or the hurricane clouds above
2. In another embodiment, the arc of sea water would be generated from air craft, preferably unmanned, flying above and away from the clouds.

3. In another embodiment, streams would be generated within the clouds by stream generation devices placed there using rockets or missiles

4. In another embodiment, the sea water will be mixed with agents that Increase the viscosity there by stabilizing the arc as it flies through the air and prevent its break up in to drops or drop lets.

Finally, It should be realized that any conductor of electricity of a suitable length that can create a short circuit between the clouds would result in increased dissipation of energy through lightning, there by reducing the energy dissipated through the wind flow.

What is claimed is a method to safely weaken hurricanes and storms by converting the potential energy of the storm systems to electromagnetic energy, that is safer than the kinetic energy of the wind motion which is destructive:

1. use of single separate contiguous streams of sea water to act as a conductor between and within the clouds to short circuit the built up static electric charges and dissipate the energy in the form of electromagnetic radiation.

2. the above system could also be used to reduce the incidence of destructive cloud to ground lightning by increasing the occurrence of intra-cloud and cloud-to-cloud lightning.
The following embodiments are proposed which may be considered as Dependent claims on claim 1:

3. In its simplest embodiment, the arc of sea water would be a few meters long and launched from surface-based vehicles into the thunderstorm or the hurricane clouds above.

4. In another embodiment, the arc of sea water would be generated from aircraft, preferably unmanned, flying above and away from the clouds.

5. In another embodiment, streams would be generated within the clouds by stream generation devices placed there using rockets or missiles.

6. In another embodiment, the sea water will be mixed with agents that increase the viscosity there by stabilizing the arc as it flies through the air, and prevent its breakup into drops or droplets.

7. Finally, it should be realized that any conductor of electricity of a suitable length that can create a short circuit between the clouds would result in increased dissipation of energy through lightning, thereby reducing the energy dissipated through the wind flow.
